(19) United States
(12) Patent Application Publication
(10) Pub. No.: US 2025/0199347 A1
(43) Pub. Date: Jun. 19, 2025

(54) ELECTCRO-OPTIC MODULATOR AND A METHOD FOR FABRICATING THE ELECTRO-OPTIC MODULATOR

(71) Applicant: DustPhotonics, Modiin (IL)

(72) Inventors: Alex Naiman, Tel Aviv (IL); Yoel Chetrit, Kfar Ben Nun (IL); Moshe Zadka, Jerusalem (IL)

(73) Assignee: DustPhotonics, Modiin (IL)

(21) Appl. No.: 18/860,678

(22) PCT Filed: Apr. 27, 2023
(86) PCT No.: PCT/IB2023/054394

§ 371 Date: Oct. 27, 2024

Related U.S. Application Data
(60) Provisional application No. 63/363,710, filed on Apr. 27, 2022.

(51) Int. Cl. G02F 1/035; G02F 1/21; G02F 1/225

(52) U.S. Cl. CPC G02F 1/0356; G02F 1/212; G02F 1/2255; G02F 1/2257

(57) ABSTRACT

An electro-optical (EO) modulator that includes (i) a substrate. (ii) a modulation unit that includes an EO modulation layer and a modulation zone waveguide that is optically coupled to the EO modulation layer and is partially surrounded by one or more gaps. (iii) radio-frequency electrodes that are electromagnetically coupled to the EO modulation layer. (iv) an input waveguide that is configured to guide light towards the modulation unit; and (v) an output waveguide that is configured to receive modulated light from the modulation unit.

### CROSS REFERENCE

This application claims priority from U.S. provisional patent Ser. No. 63/363,710 filing date Apr. 27, 2022, which is incorporated herein by reference.

### BACKGROUND OF THE INVENTION

Devices for fast optical modulation based on doped silicon are limited to frequencies of about 35 GHz with reasonable optical loss and efficiency.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1-4 illustrate examples of an electro-optic (EO) modulator;

FIG. 5 illustrates an example of a propagation of light through the EO modulator;

FIG. 6 illustrates an example of a Mach-Zander-Modulator (MZM);

FIG. 7 illustrates an example of a Mach-Zander-Modulator (MZM);

FIGS. 8-13 illustrate example of phases during a fabrication process of an electro-optic modulator;

FIG. 14 illustrates an example of a method; and

FIG. 15 illustrates an example of a method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF THE PREFERRED EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

Because the illustrated embodiments of the present invention may for the most part, be implemented using optical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

There may be provided a method for fabrication of electro-optic modulator where a thin film lithium niobate chip is bonded on top of a silicon photonics wafer. an optical waveguides on the silicon wafer couple light to the chip from an external source, routing of the light to an active modulation region and coupling the modulated light out of the chip. where the active modulation is achieved by applying high frequency RF signal on a hybrid silicon nitride and lithium niobate waveguide.

The electro-optic modulator exhibits a reduction of optical loss-which is obtained at least in part by using a aluminum covered copper metal lines to mitigate the optical loss due to TaN layer in the copper deposition process and addition of air voids around the optical waveguides for enhanced optical confinement.

The method for fabrication may be tailored to enable fully operational high speed optical modulator with all the necessary components integrated within the silicon wafer e.g. photodiodes, termination resistors, grating couplers.

The electro-optic modulator may include a Silicon chip and Electro-optical materials such as Lithium Niobate for fast optical modulation with low optical loss and high modulation efficiency.

The electro-optic modulator may be configured to perform fast optical modulation with electro-optical materials (in this case Lithium niobate but not limited to) with compatibility to CMOS and silicon photonics fabrication processes.

In order to increase the efficiency of the electro-optic modulator the electro-optic modulator may include metal traces as close as possible to the optical mode.

In order to reduce the optical loss the metal traces may be positions far from the metal, since light leakage to the metal induces optical loss.

The electro-optic modulator may include metal of high conductivity (for example Cu) which may reduce losses at frequencies that exceed 1 Ghz (microwave) of the transmission line of the electro-optic modulator and improves the performance of the electro-optic modulator.

Due to coppers diffusion properties, the electro-optic modulator may include Tantalum Nitride or Tantalum as copper barrier layer on the bottom and sidewalls of the copper metal trace lines.

Both Ta and TaN have very high optical loss in the near IR part of the spectrum which is used for data communication applications—and this can be used as a copper barrier layer.

There is provided an EO modulator that includes a (i) substrate, (ii) a modulation unit that comprises an EO modulation layer and a modulation zone waveguide that is optically coupled to the EO modulation layer and is partially surrounded by one or more gaps; (iv) radio-frequency electrodes that are electromagnetically coupled to the EO modulation layer; (v) an input waveguide that is configured to guide light towards the modulation unit; and (vi) an output waveguide that is configured to receive modulated light from the modulation unit.

A gap of the one or more gaps is at least partially filled with one or more gases.

A gap of the one or more gaps is at least partially filled with air.

A gap of the one or more gaps is a vacuumed gap.

The EO modulator may include one or more light barriers. A light barrier can be located between the modulation zone waveguide and (i) the radio-frequency electrodes and/or (ii) the radio frequency electrode diffusion barrier layers.

EO modulation layer may be a Lithium Niobate (LN) layer.

The modulation zone waveguide can be made of Silicon nitride (SiN) or silicon or Silicon rich nitride.

The one or more light barriers are configured to reduce the absorption of light (modulated light and/or unmodulated light) by the EO modulator.

The one or more light barriers may be glued to the radio-frequency electrodes. A deposition process can be used instead of the gluing or in addition to the gluing. The light barriers may be deposited on the RF electrodes.

The modulation zone waveguide may include sidewalls that are exposed to the one or more gaps. It should be noted that one or more other part of the modulation zone waveguide may be exposed to a gap—in addition to and/or instead of the sidewalls.

The modulation zone waveguide may include a bottom that is supported by an oxide element that is higher than a bottom of a gap of the one or more gaps.

The EO modulator may include an isolation layer and a first handle that are positioned above the EO modulation layer.

The modulation unit may be manufactured by a manufacturing process that includes: obtaining a first object that comprises the EO modulation layer, obtaining a second object that comprises the modulation zone waveguide, inserting the second object to a recess formed within the first object, and attaching the first object to the second object.

The EO modulator may include an isolation base that supports the modulation zone waveguide and the radio-frequency electrodes.

The modulation unit, the radio-frequency (RF) electrodes, the an input waveguide and the an output waveguide may belong to a first arm of a Mach-Zehnder Modulator (MZM). The modulation unit, the RF electrodes, the an input waveguide and the an output waveguide may not belong to the MZM.

The EO modulator may include another modulation unit, others RF electrodes, another input waveguide and another output waveguide that belong to a second arm of the MZM.

There may be provided a method for EO modulation, the method may include (i) guiding, by at least an input waveguide of an EO modulator, light towards a modulation unit of the EO modulator, the modulation unit comprises an EO modulation layer and a modulation zone waveguide that is optically coupled to the EO modulation layer and is partially surrounded by one or more gaps; (ii) modulating the light, by the modulation unit, under a control of RF electrodes that are electromagnetically coupled to the EO modulation layer, to provide modulated light; and (iii) outputting, by at least an output waveguide of the EO modulator, the modulated light.

The method may include reducing an absorption, within the EO modulator of at least one of the light and the modulated light, by one or more light barriers of the EO modulator.

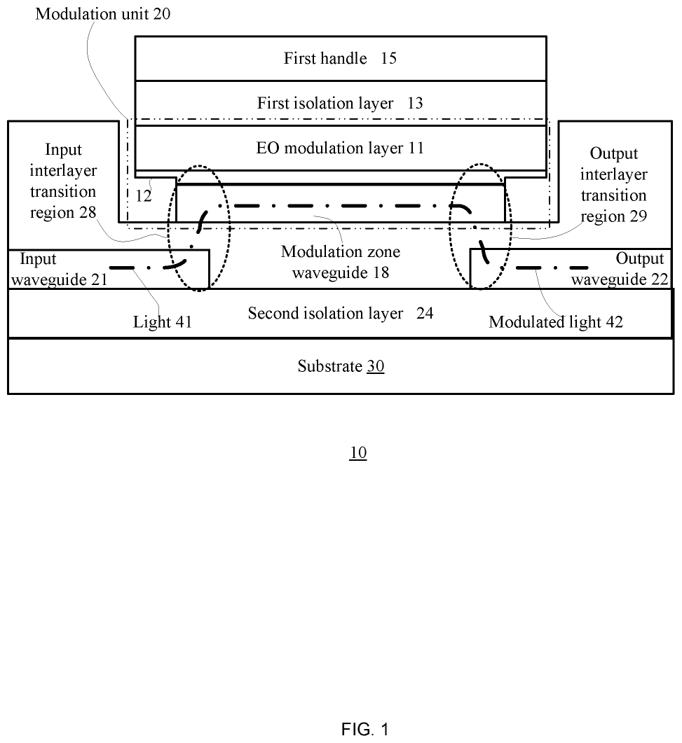

FIG. 1 illustrates a cross section of an EO modulator along a longitudinal plane that is parallel to the propagation of the light through the EO modulator.

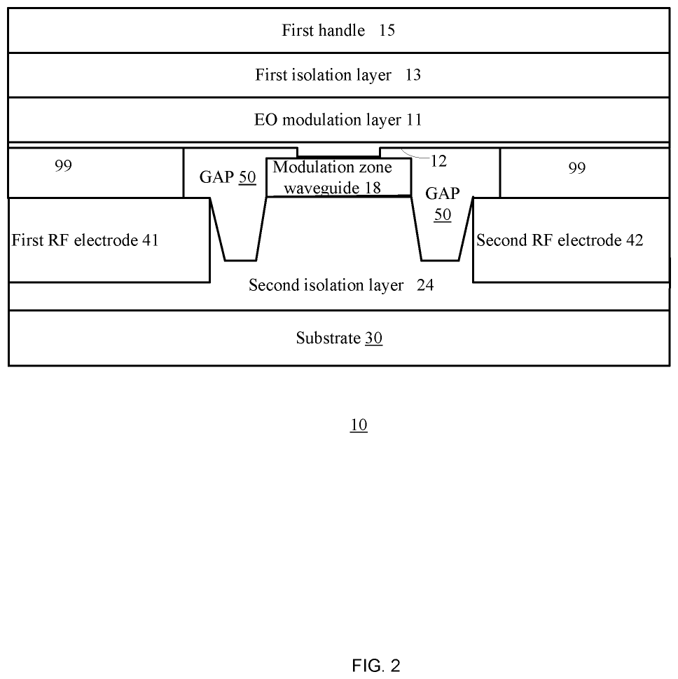

FIG. 2 illustrates a cross section of an EO modulator along a transverse plane that is normal to the propagation of the light through the EO modulator.

FIGS. 1 and 2 illustrate an EO modulator 10 includes a (i) substrate 30, (ii) a modulation unit 20 that includes EO modulation layer 11 (can be made of Lithium Niobate) and a modulation zone waveguide 18 that is optically coupled to the EO modulation layer 11 and is partially surrounded by one or more gaps (50); (iv) RF electrodes (such as first RF electrode 41 and second RF electrode 42) that are electromagnetically coupled to the EO modulation layer; (v) an input waveguide 21 that is configured to guide light towards the modulation unit; (vi) an output waveguide 22 that is configured to receive modulated light from the modulation unit, (vii) a first interlayer transition region 28 in which the light, via evanescent coupling is guided from the input waveguide to the modulation zone waveguide 18, (viii) a second interlayer transition region 29 in which the modulated light, via evanescent coupling is guided from the modulation zone waveguide 18 to the output waveguide, and (ix) an additional isolation region 99. The additional isolation region 99 may or may not be a part of the second isolation layer 24 and/or may contact the second isolation layer or be spaced apart from the second isolation layer.

FIG. 1 also illustrates the propagation of light 41 and modulated light 42.

FIG. 1 also illustrates first isolation layer 13 and first handle 15 located above EO modulation layer 11—and also illustrates second isolation layer 24 and substrate-located below the modulation zone waveguide.

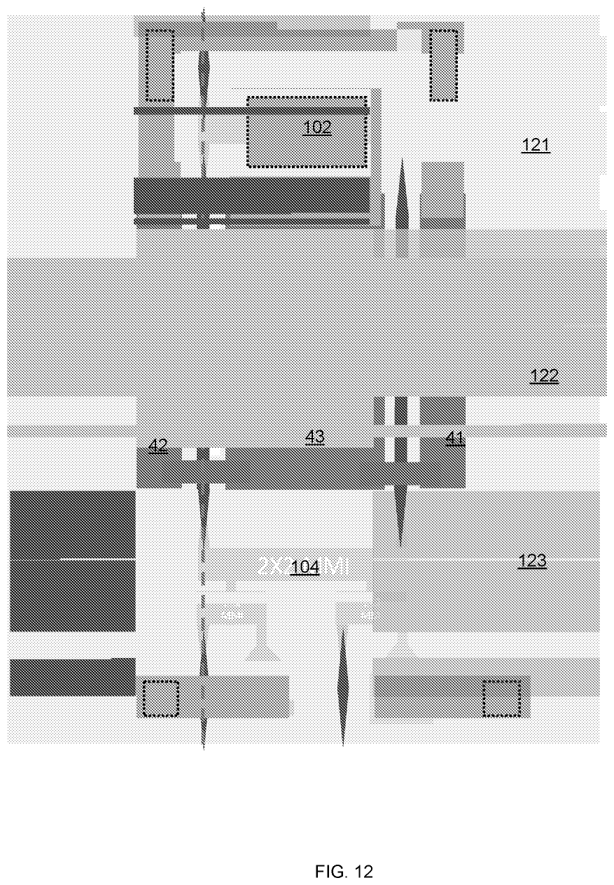

FIG. 12 also illustrate a gap oxide layer 12 located between the EO modulation layer 11 and the modulation zone waveguide 18.

FIG. 2 also illustrates gaps 50 that have a bottom that is located below the bottom of the modulation zone waveguide 18.

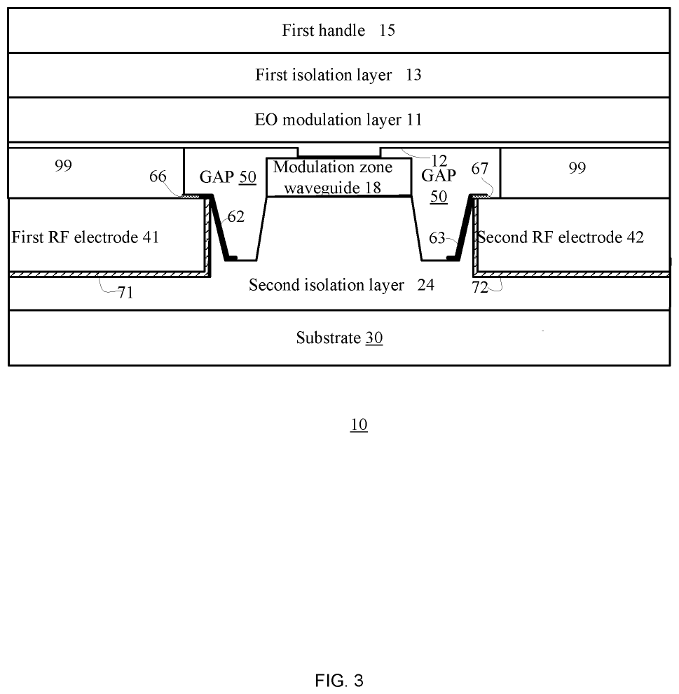

FIG. 3 illustrates a cross section of an EO modulator along the transverse plane that is normal to the propagation of the light through the EO modulator.

FIG. 3, differs from FIG. 2 by further illustrating first and second light barriers 62 and 63. The light barriers are located between the modulation zone waveguide 18 and (i) first and second RF electrodes 41 and 42 respectively and/or (ii) the first and second radio frequency electrode diffusion barrier layers 71 and 72 (can be made of Tantalum or Tantalum nitride Cu) respectively.

The one or more light barriers are configured to reduce the absorption of light (modulated light and/or unmodulated light) by the EO modulator

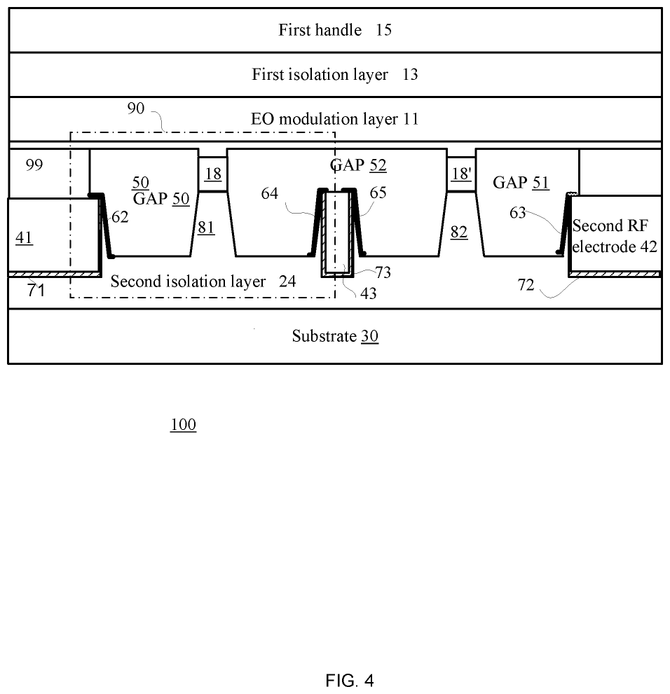

FIG. 4 illustrates a cross section of an EO modulator that is a MZM 100 with two arms, the cross section is taken along transverse plane that is normal to the propagation of the light through the EO modulator.

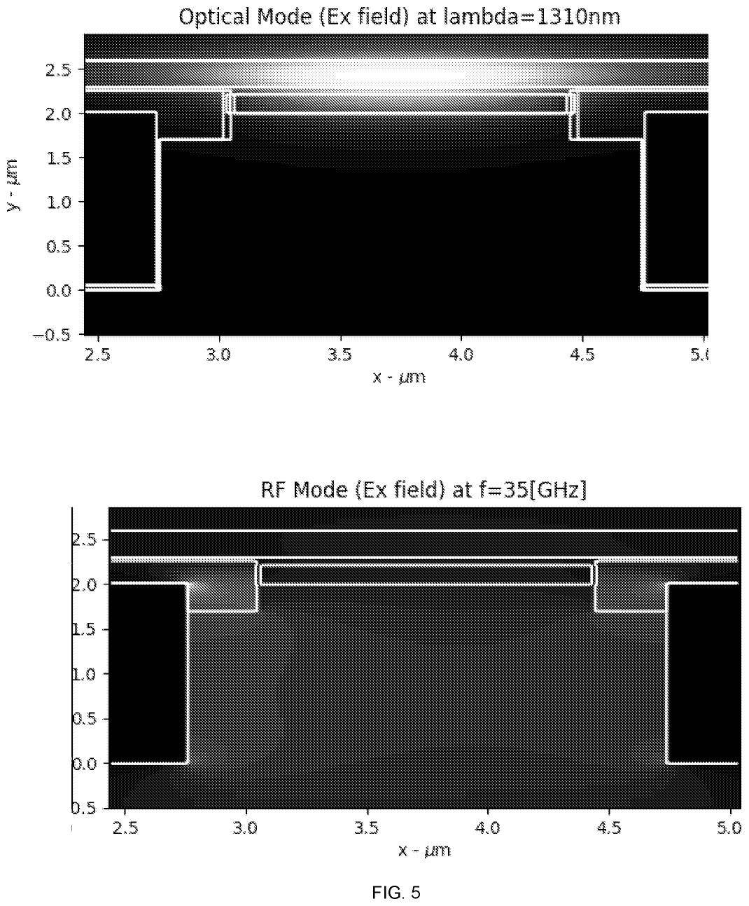

FIG. 5 illustrates the propagation of light through a segment (denoted 90 in FIG. 4) of light and also illustrates the electromagnetic field through the segment.

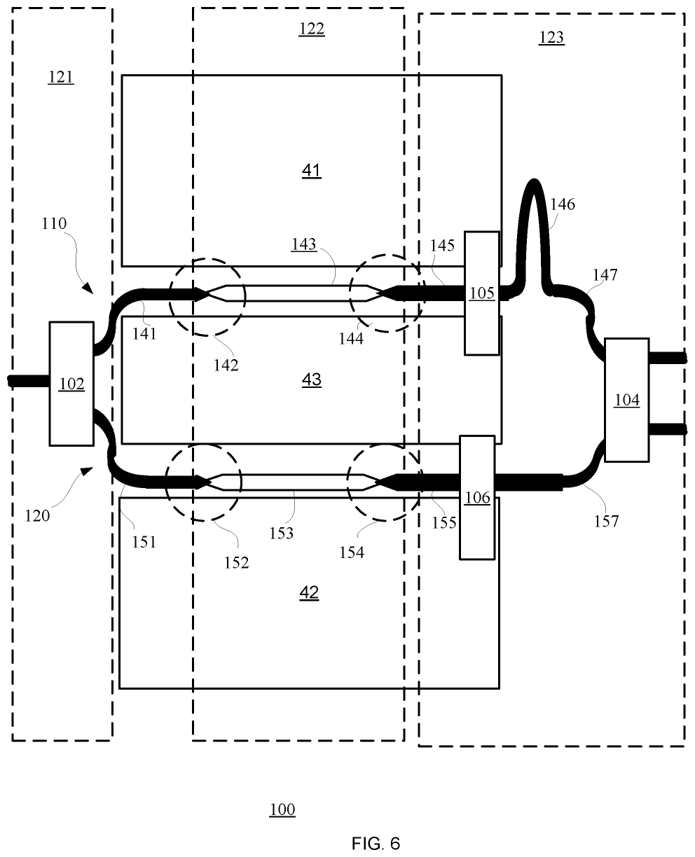

FIG. 6 is a top view of the MZM 100.

Referring to FIGS. 4-6—the MZM includes:
a. Splitter 102
b. Two arms-first arm 110 and second arm 120. The first arm includes a first input waveguide 141, a first modulation zone waveguide 143, and a first output waveguide. The second arm includes a second input waveguide 151, a second modulation zone waveguide 153, and a second output waveguide.
c. Each arm includes the EO modulator illustrated in FIGS. 1 and 2 or 3, as well as impedance matching resistors 105 and 106. The first arm 11—also includes a delay unit 145, and both output waveguides have a first segment (145 and 155 respectively) before the impedance matching resistor, and a second segment (147 and 157 respectively).
d. 2×2 splitter 104.

The delay unit introduced a delay that reduces the free spectral range of the optical interference.

In the 2×2 splitter the interference between the light modulated from the first and second arms occurs and converts the phase modulation intruduced by the first and second modulation units into amplitude modulation. After the 2×2 splitter the light is coupled out of modulator to a fiber or any other component.

FIG. 6 also illustrates the MZM as including (a) a first thick oxide layer 121 that covers splitter 102, a most of first input waveguide 141 of first arm 110, and most of second input waveguide 142 of second arm 120, (b) a combination 122 (may be referred to as modulation layer chip) of an EO modulation layer, a first isolation layer and a first handle, (c) a second thick oxide layer 123 that covers most of the first and second output waveguides, the delay unit 145 and the 2×2 splitter 103, (d) a first RF electrode 41 that may be grounded, (e) a second RF electrode 42 that may be grounded, and (f) a third RF electrode 43 that may receive a modulating RF signal.

FIG. 4 illustrates (from left to right):
a. First RF electrode 41.
b. First RF electrode diffusion barrier layer 71.
c. First light barrier 62.
d. First gap 50.
e. First oxide support element 81—which is a protrusion that supports the first modulation zone waveguide.
f. First modulation zone waveguide 18.
g. First part of second gap 52.
h. Second light barrier 63.
i. Third light barrier 64.
j. Third electrode 43 and third RF electrode diffusion barrier layer 73, that are partially surrounded by oxide.
k. Fourth light barrier 65.
l. Second part of second gap 52.
m. Second oxide support element 82—which is a protrusion that supports the second modulation zone waveguide 18′.
n. Second light barrier 62.
o. Second RF electrode diffusion barrier layer 72.
p. Second RF electrode 42.

FIG. 4 further illustrates first handle 15, first isolation layer 13, EO modulation layer 11, second isolation layer 24 and substrate 30.

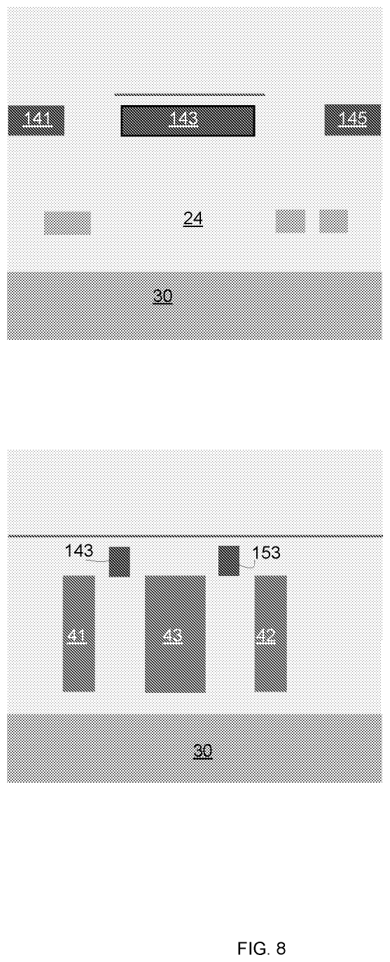

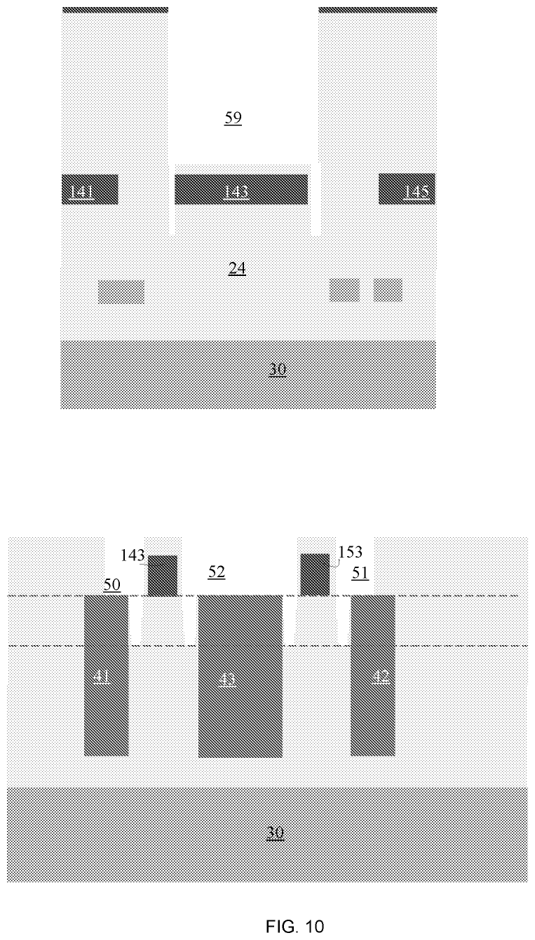

FIGS. 8-13 illustrates a manufacturing process. They illustrates various elements of the EO modulator and also may illustrate intermediate elements that are not seen in the EO modulation at the completion of the manufacturing process of the EO modulator—for example intermediate gap 59 of FIG. 10. The various elements shown in one or some of FIGS. 8-13 include substrate 30, second isolation layer 24, gap 50, gap 52, gap 51, first input waveguide 141, first modulation zone waveguide 143, first output waveguide 145, second modulation zone waveguide 153, first electrode 41, second electrode 42, third electrode 43, first light barrier 62, second light barrier 63, third light barrier 64, fourth light barrier 65, 1×2 splitter 102, 2×2 splitter 104, first thick oxide layer 121, combination 122 (may be referred to as modulation layer chip) of an EO modulation layer, a first isolation layer and a first handle, and second thick oxide layer 123.

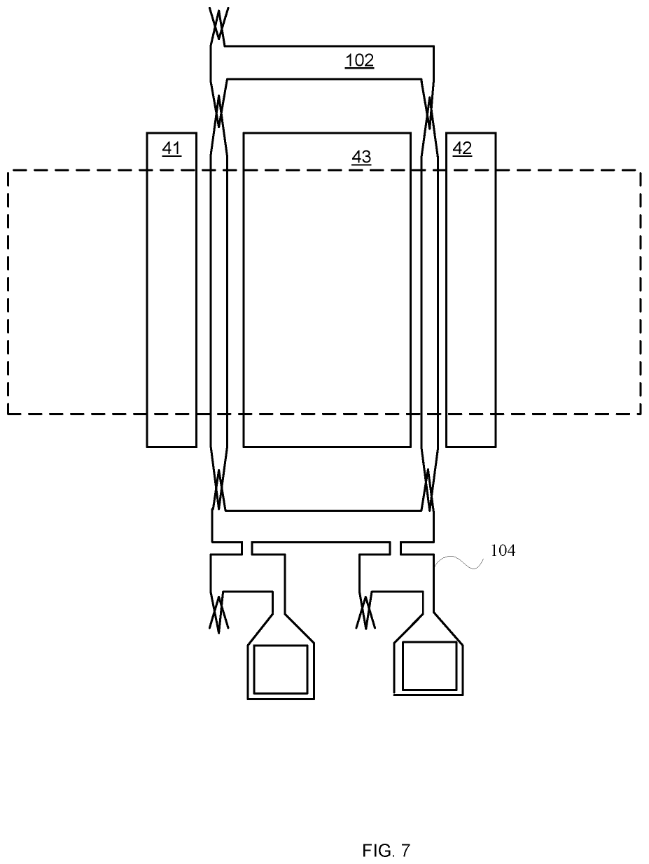

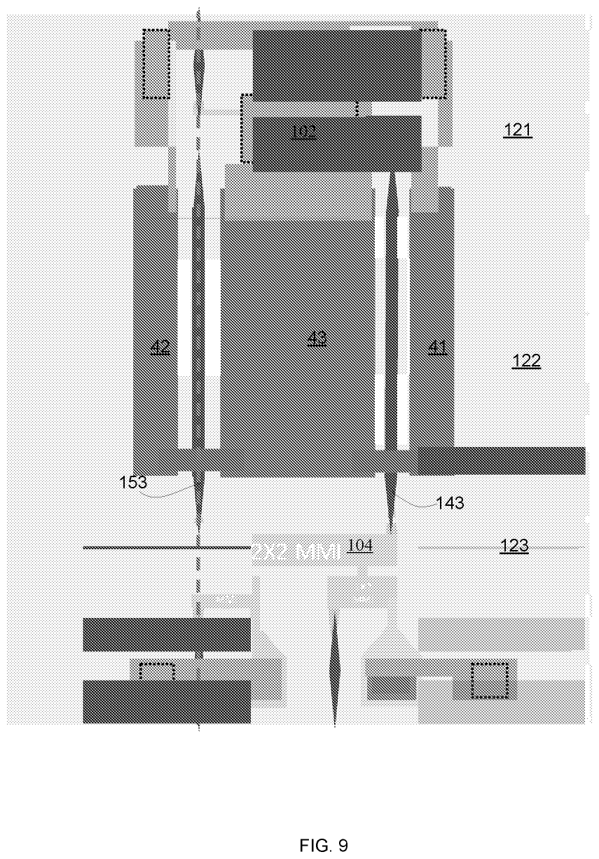

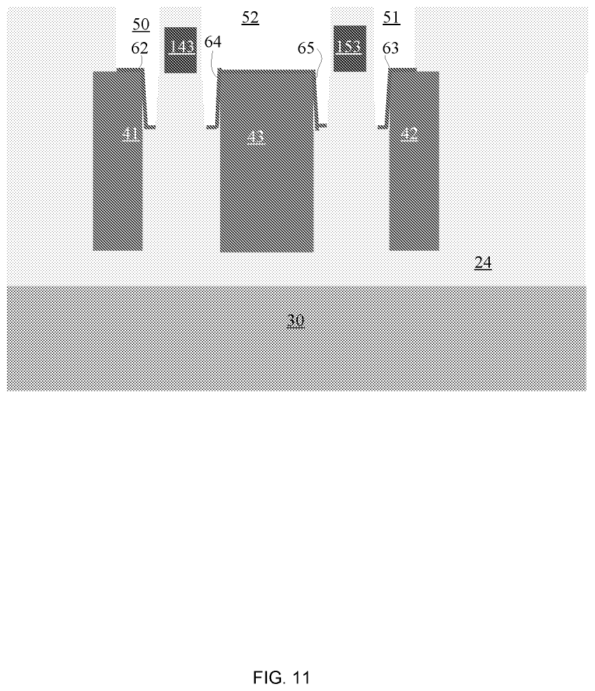

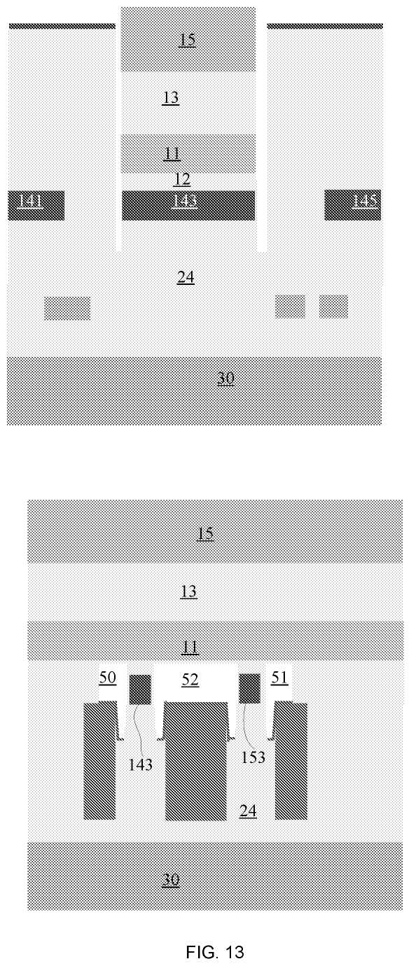

FIGS. 7 and 8 illustrate a top view, and two cross sectional views of an certain (K′th) stage of the manufacturing process. FIGS. 9 and 10 illustrate a top view, and two cross sectional views of the (K+1)′th stage of the manufacturing process. FIG. 11 illustrates a cross sectional view of the (K+2)′th stage of the manufacturing process. FIGS. 12 and 13 illustrate a top view, and two cross sectional views of the (K+2)′th stage of the manufacturing process.

FIGS. 7-8 illustrate the deposition and patterning steps of a thin Al layer which acts as a protective layer for the deep oxide etch step—the benefit is the protection of the thin oxide underneath maintaining its original thickness and uniformity which also yields low post-etch surface roughness that is beneficial for a later bonding step.

The importance of having a low roughness and uniformly thick gap oxide layer lies in two aspects: the first one is mechanical due to the requirements of the bonding procedure, requiring a uniformly flat surface with sub-nanometer surface roughness. Any variations in oxide thickness can result in poor bonding and the formation of voids.

Furthermore, surface roughness above the nanometer scale can reduce the yield of the bonding process below acceptable values. Second, the gap oxide plays a crucial role in the optical domain where the group index is determined by the geometry and the material composition of the optical waveguide.

Thickness variations in the gap oxide which resides in the middle of the optical mode between the lithium niobate and the silicon nitride layer may result in variations in the group index of the optical mode resulting in index mismatch to the propagating RF mode and performance degradation.

Third, the uniformity of the oxide layer enabled by the process disclosed in this invention reduces significantly the device performance variations within dies, die to die, and wafer to wafer variations. Hence, increasing the yield.

FIGS. 9-10 illustrates oxide etching around the SiN waveguides and the metal lines. The modulator may benefit from the etching around the SiN waveguide as it provides a higher mode confinement due to higher refractive index difference between the core of the waveguide and the cladding which in turn allows one to position the metal lines closer to the waveguide and increasing the modulation efficiency. Furthermore—the benefit of etching around the metal lines is to reveal them for the next fabrication step.

FIG. 11 illustrates the coating of the copper metal lines with thin layer of Al. This stage assist in providing a modulator with a reduced optical loss of the phase shifter. It is achieved due to the low penetration depth of the light in the Al layer making this layer act effectively as a mirror to the light, preventing it from reaching the very lossy barrier layer of the copper underneath.

FIGS. 12-13 illustrate a bonding the thin film lithium niobate die to the wafer with the patterned modulator. This step allows the LN to act as the electro-optic material responsible to conversion of the electrical modulation in the microwave lines to modulation of the optical mode.

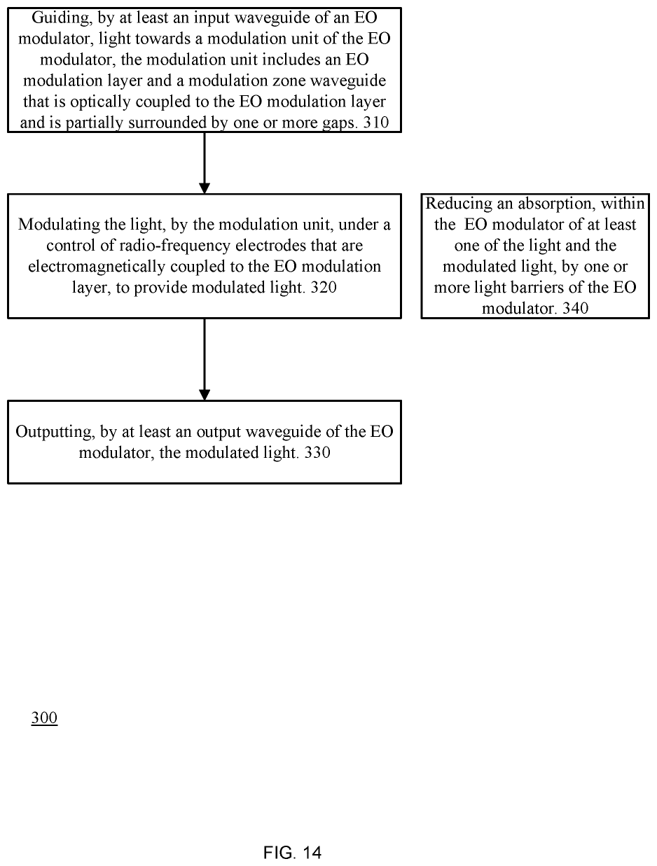

FIG. 14 illustrates an example of method 300.

Method 300 may be executed by EO modulator 10.

Method 300 may start by step 310 of guiding, by at least an input waveguide of an EO modulator, light towards a modulation unit of the EO modulator, the modulation unit includes an EO modulation layer and a modulation zone waveguide that is optically coupled to the EO modulation layer and is partially surrounded by one or more gaps.

Step 310 may be followed by step 320 of modulating the light, by the modulation unit, under a control of radio-frequency electrodes that are electromagnetically coupled to the EO modulation layer, to provide modulated light.

Step 320 may be followed by step 330 of outputting, by at least an output waveguide of the EO modulator, the modulated light.

Method 300 may include step 340 of reducing an absorption, within the EO modulator of at least one of the light and the modulated light, by one or more light barriers of the EO modulator.

Step 340 may be executed in parallel to step 320 and to at least one other step of method 300.

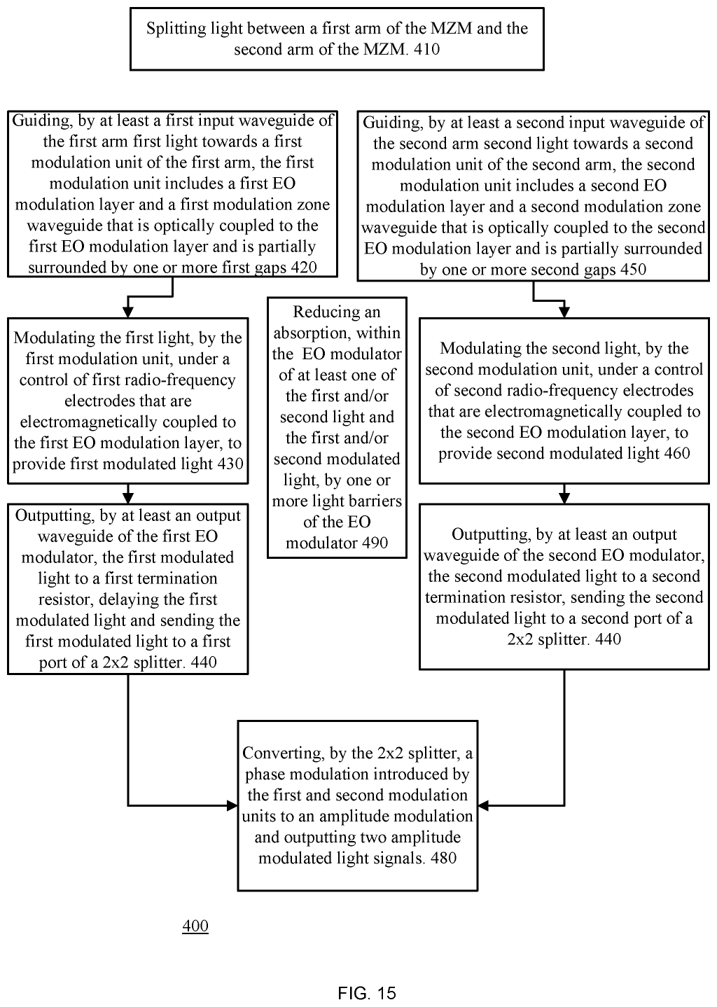

FIG. 15 illustrates an example of method 400.

Method 300 may be executed by EO modulator 100 that is an MZM.

Method 400 may start by step 410 of splitting light between a first arm of the MZM and the second arm of the MZM.

Step 410 is followed by steps 420 and 450.

Step 420 includes guiding, by at least a first input waveguide of the first arm first light towards a first modulation unit of the first arm, the first modulation unit includes a first EO modulation layer and a first modulation zone waveguide that is optically coupled to the first EO modulation layer and is partially surrounded by one or more first gaps.

Step 420 may be followed by step 430 of modulating the first light, by the first modulation unit, under a control of first radio-frequency electrodes that are electromagnetically coupled to the first EO modulation layer, to provide first modulated light.

Step 430 may be followed by step 440 of outputting, by at least an output waveguide of the first EO modulator, the first modulated light to a first termination resistor, delaying the first modulated light and sending the first modulated light to a first port of a 2×2 splitter.

Step 450 includes guiding, by at least a second input waveguide of the second arm second light towards a second modulation unit of the second arm, the second modulation unit includes a second EO modulation layer and a second modulation zone waveguide that is optically coupled to the second EO modulation layer and is partially surrounded by one or more second gaps.

Step 450 may be followed by step 460 of modulating the second light, by the second modulation unit, under a control of second radio-frequency electrodes that are electromagnetically coupled to the second EO modulation layer, to provide second modulated light.

Step 460 may be followed by step 470 of outputting, by at least an output waveguide of the second EO modulator, the second modulated light to a second termination resistor, and sending the second modulated light to a second port of a 2×2 splitter.

When performing Mach-Zander modulation, the first light and the second light undergo the same modulation—for example with the flipped polarity of the RF field. For example, if the first arm “feels” the RF field in one direction the second arm should “feel” the same amplitude of RF field in the other direction.

Steps 440 and 470 are followed by step 480 of converting, by the 2×2 splitter, a phase modulation introduced by the first and second modulation units to an amplitude modulation and outputting two amplitude modulated light signals.

Method 400 may include step 490 of reducing an absorption, within the EO modulator of at least one of the light and the modulated light, by one or more light barriers of the EO modulator.

Step 490 may be executed in parallel to steps 430 and 460 and to at least one other step of method 400.

TABLE 1
example of dimensions

| | Suggested | |
|---|---|---|
| Properties | value | Benefits |
| Thickness of RF | 3 micron | Can support high currents which |
| electrodes | | are required for the reliable |
| | | operation of the modulator |
| Distance between RF | 400 nm | Higher electric field reaching |
| electrodes and the | | the active material—more |
| active material | | efficient operation |
| Thick oxide cover 121 | 3 micron | Allows larger mode area at |
| and 123 in FIG. 6 | | the output—higher coupling |
| | | efficiency to SMF |
| On-chip termination | Present by | On-chip termination allows |
| | TiN layer | lower RF reflections |
| | | and higher BW |
| On chip PD | Part of the | Acts as power monitor to |
| | design | maintain the working point. |
| Metal used for traces | Cu | Cu has higher conductivity |
| | | and lower roughness allowing |
| | | reduction in RF propagation |
| | | loss and optical loss |
| Air gaps | Having | Due to higher refractive |
| | height and/or | index difference, the |
| | width of | optical mode leaks less |
| | micron or | to the metal->lower |
| | submicron | optical loss |
| | scale | |

Any reference to microwave should be applied, mutatis mutandis, to radio frequency (RF). Any reference to RF should be applied, mutatis mutandis, to microwave.

Any reference to any of the terms “comprise”, “comprises”, “comprising” “including”, “may include” and “includes” may be applied to any of the terms “consists”, “consisting”, “consisting essentially of”. For example—any of the rectifying circuits illustrated in any figure may include more components that those illustrated in the figure, only the components illustrated in the figure or substantially only the components illustrated in the figure.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. An electro-optical (EO) modulator, comprising:
a substrate;
a modulation unit that comprises an EO modulation layer and a modulation zone waveguide that is optically coupled to the EO modulation layer and is partially surrounded by one or more gaps;
radio-frequency electrodes that are electromagnetically coupled to the EO modulation layer;
an input waveguide that is configured to guide light towards the modulation unit; and
an output waveguide that is configured to receive modulated light from the modulation unit.

2. The EO modulator according to claim 1 wherein a gap of the one or more gaps is at least partially filled with one or more gases.

3. The EO modulator according to claim 1 wherein a gap of the one or more gaps is at least partially filled with air.

4. The EO modulator according to claim 1 wherein a gap of the one or more gaps is a vacuumed gap.

5. The EO modulator according to claim 1 comprising one or more light barriers that are located between the modulation zone waveguide and the radio-frequency electrodes.

6. The EO modulator according to claim 1 comprising one or more light barriers that are located between the modulation zone waveguide and radio frequency electrode diffusion barrier layers.

7. The EO modulator according to claim 1, wherein the EO modulation layer is a Lithium Niobate (LN) layer.

8. The EO modulator according to claim 1, wherein the modulation zone waveguide is made of Silicon nitride (SiN).

9. The EO modulator according to claim 1, wherein the modulation zone waveguide is made of silicon.

10. The EO modulator according to claim 1, comprising one or more light barriers that are configured to reduce the absorption of light by the EO modulator.

11. The EO modulator according to claim 10, wherein the one or more light barriers are glued to the radio-frequency electrodes.

12. The EO modulator according to claim 1, wherein the modulation zone waveguide comprises sidewalls that are exposed to the one or more gaps.

13. The EO modulator according to claim 1, wherein the modulation zone waveguide comprises a bottom that is supported by an oxide element that is higher than a bottom of a gap of the one or more gaps.

14. The EO modulator according to claim 1, comprising an isolation layer and a first handle that are positioned above the EO modulation layer.

15. The EO modulator according to claim 1, wherein the modulation unit is manufactured by a manufacturing process that comprises:
obtaining a first object that comprises the EO modulation layer;
obtaining a second object that comprises the modulation zone waveguide;
inserting the second object to a recess formed within the first object; and
attaching the first object to the second object.

16. The EO modulator according to claim 1, comprising an isolation base that supports the modulation zone waveguide and the radio-frequency electrodes.

17. The EO modulator according to claim 1, wherein the modulation unit, the radio-frequency electrodes, the an input waveguide and the an output waveguide belong to a first arm of a Mach-Zehnder Modulator (MZM).

18. The EO modulator according to claim 1, the modulation zone waveguide can be made of Silicon nitride (SiN) or silicon or silicon rich nitride.

19. The EO modulator according to claim 17, comprising another modulation unit, others radio-frequency electrodes, another input waveguide and another output waveguide that belong to a second arm of the MZM.

20. A method for electro-optical (EO) modulation, the method comprising:
guiding, by at least an input waveguide of an EO modulator, light towards a modulation unit of the EO modulator, the modulation unit comprises an EO modulation layer and a modulation zone waveguide that is optically coupled to the EO modulation layer and is partially surrounded by one or more gaps;
modulating the light, by the modulation unit, under a control of radio-frequency electrodes that are electromagnetically coupled to the EO modulation layer, to provide modulated light; and
outputting, by at least an output waveguide of the EO modulator, the modulated light.

21. The method according to claim 20, comprising reducing an absorption, within the EO modulator of at least one of the light and the modulated light, by one or more light barriers of the EO modulator.
